(19) United States
(12) Patent Application Publication
(10) Pub. No.: US 2008/0122133 A1
(43) Pub. Date: May 29, 2008

(54) Method of animal skins fragmentation, reorganization and molding & a product of reorganized skin

(76) Inventor: Jingmin Zheng, Zhejiang (CN)

Correspondence Address: LADAS & PARRY LLP, 26 WEST 61ST STREET, NEW YORK, NY, 10023, US

(21) Appl. No.: 11/789,570

(22) Filed: Apr. 25, 2007

(30) Foreign Application Priority Data
Nov. 23, 2006 (CN) 200610145930.1

(51) Int. Cl. B29C 71/02

(52) U.S. Cl. 264/102; 264/234

(57) ABSTRACT

The present invention provides a method of animal skins fragmentation, reorganization and molding and a product of reorganized skin was made up. The method includes wet grinding wet animal skins after fulling them with water; adding pieces of animal meat, vegetables, fruit and/or vegetable juice and fruit Juices into the comminuted wet skin at the temperature of 20-90° C., and the amount should be less than 70 wt. % of the total weight; and then degassing, shaping, placeing, gelling, and drying the wet skins; Before the degassing approach, a step of adding aycl/aldehyde-transfer enzyme which is less than 3.5 wt. % of the total weight into comminuted wet shin and mixing them thoroughly in temperature of 20-70° C. can also be in the progress. The reorganized skin is 0.2-10 mm thick, and it can be used as feed for pets. For example, it can be shaped as various forms of dog chew toys, artificial dog bones, edible pet toys or directly used for packing products by plastic forming mold.

### FIELD OF THE INVENTION

This present invention relates to a method of animal skins treats; more particularly, this relates to a method of animal skins fragmentation, reorganization and molding and its product of reorganized skin which belong to the field of animal foods.

### PRIOR ART

What cause animal skins soft and flexible is a structure protein, namely Collagen protein. Collagen protein has a unique 3 section super-helical structure, each of the 3 polypeptide chains are left-handed helix, and 3 polypeptide chains form a solid right-handed super-helix. The super-helix state is very stable in low water content, so it can't decompose in common heating temperature or in short time. But in high water content, Collagen protein may fragmentate through ways of: (1) covalent bond hydrolyzing fragmentation; (2) hydrogen bond or static bond looseing fragmentation caused by thermal denaturing. After fragmentation, Collagen protein will be disorganized, and the 3 voluble polypeptide chains will loosen and then dissolve in water to form a ruleless clew, namely Gelatin. Therefore, it is difficult for reorganized skin to have the glutinosity, flexibility and tensility as good as natural animal skins.

Currently, there has been years for producing artificial collagen membrane and sausage by using reframed collagen of natural animals. Furthermore, the major source of animal collagen is moo-cow collagen from cowskin, which is made by separating the underlayer of cowskin collagen after butchering the moo-cow and peeling off its skin. Then according a known way, mechanically switch the moo-cow collagen into a gel; extrude the gel to form a tablets enteric-coated; solidify the tablets enteric-coated by typically changing its pH and/or using crosslinker, e.g. glutaric dialdehyde. However, the use of pig collagen is rarely little, mainly because of a relatively low tensile strength of the artificial pig collagen membrane and collagen sausage. In the current available technology, the Chinese patent CN1045364C open a method using pig collagen to make sausage. The method uses cattle, pigs and other animal skins as raw materials, and its steps include washing the animal skins with acid/alkuli, grinding them, puting additive (e.g. polyvinyl alcoholic aldehyde condensation compound) into them, and then making them into tubular casing by methods of pushing and bath-law concreting, and then a 0.03˜0.1 mm sausage casing is finally created by processes in a sequence of drying, modification, folding or shrinking. T. Morgan et al. also opened a method extruding the gel including pig collagen, fat and moisturizing agent to make casing for food (e.g. sausage). However, this method is relatively complicated, for it needs to adjust the match rate of collagen, fat and moisturizing agent in raw materals, and it also desires a complicated defatted process. The method of using, mixture of pig collagen and cattle collagen to make sausage enteric-coated is opened in U.S. Pat. No. 4,407,829, U.S. Pat. No. 5,411,887 and U.S. Pat. No. 5,840,849, in where something is not mentioned, such as the raw materials using mixture of pig collagen and cattle collagen, the accession of other nutritions (such as domentic animals, birds, fish, meat, vegetables and fruits), and the accession of flavor, sauce and aycl/aldehyde-transfer enzyme. Further more, in U.S.A. patent, there are not any methods for reorganizing skins which are 0.2 mm˜10 mm thick and have the glutinosity, flexibility and tensility as good as natural animal skins.

To conclude, the present invention provides a method of animal skins fragmentation, reorganization and molding. It uses mixture of pig collagen and/or cattle collagen as raw material, and other nutritions (such as domentic animals, birds, fish, meat, vegetables and fruits), spices and flavoring and aycl/aldehyde-transfer enzyme can all be put into the wet skin in order to make reorganized skins which are 0.2 mm˜10 mm thick and have the glutinosity, flexibility and tensility as good as natural animal skins.

### SUMMARY

One of the purposes of this invention is to provide a method of animal skins fragmentation, reorganization and molding, and the method is simple and convenient for production.

Another aim of the present invention is to provide a foldable reorganized skin that has good flexibility and/or has a combined flavor of other animals. To achieve the purposes above, the invention using the following technique scheme:

A method of animal skins fragmentation, reorganization and molding includes the following steps:
(1) Wet grinding wet animal skins after fulling them with water;
(2) Adding pieces of animal meat, vegetables, fruit and/or vegetable juice and fruit juices into the comminuted wet shin at the temperature of 20-90° C., better in 55-90° C. and best at 55-75° C.; And the amount should be less than 70 wt. % of the total weight, better less than 40 wt. % and best 35 wt. %.; and
(3) Directly degassing, shaping, placeing, gelling, and drying the wet skin after mixing them thoroughly, where directly means never put aycl/aldehyde-transfer enzyme into the skins; Or before the degassing approach, a step of adding aycl/aldehyde-transfer enzyme which is less than 3.5 wt. % of the total weight into comminuted wet shin and mixing them thoroughly at temperature of 20-70° C. can also be in the progress.

In this method, the wet skins are immersed wet animal skins; the animal skins are dry shins and/or keep-fresh wet skins; the animal skins are cowskins and/or pigskins; the animal skins are full skins, first layer skins and/or second layer skins.

Thereinto, the wet grinding method is using steel mill or colloid mill or other machine to pulp and refine the wet skins; Degassing process is vacuum degassing.

The aycl/aldehyde-transfer enzyme's addition should be less than 1.0 wt. % of the total weight, and less than 0.5 wt. % is better; the aycl/aldehyde-transfer enzyme should be transglutaminase (TG enzyme).

Spices and flavoring can be put into the wet skin in step (2), with the addition amount should be less than 2.5 wt. % of the total weight, and less than 1.5 wt. % is better; Thereinto, spices include essence and flavor, and the flavoring includes common salt, white gtanulated sugar, glucose, cheese powder, cocoa powder, honey, monosodium glutamate (HVP), hydrolyzed vegetable protein and HYP.

The placing process should be standing, and the standing time is 2 min-6 h.

The reorganized skin is 0.2-1 mm thick, better 0.5-10 mm and best 1-10 mm.

The reorganized skin can be used as feed for pets, for example, it can be shaped as various forms of or dog chew toys, artificial dog bones or edible pet toys.

The reorganized skin can be directly used for packing.

The invention uses mixture of pig collagen and/or cattle collagen as raw material, and aycl/aldehyde-transfer enzyme can be put into the wet skin in order to make reorganized skins which are 0.2 mm˜10 mm thick and have the glutinosity, flexibility and tensility as good as natural animal skins, with many kinds of taste and rich nutrition, and can be animal feed applied in food packing or a kind of pets food or edible pet toy.

### DETAILED DESCRIPTION OF THE INVENTION

The followings are the further illumination of the invention in detailed examples, but the protective extension of the invention is not only confined to the examples.

Weight percentage in the following examples is counted according to the wet skin's total weight.

### EXAMPLE 1

Wet grinde wet pig skins with steel mill after fulling them with water, and maintain a temperature at 55° C. Next, adding pieces of pig meat and cacao powder into the pig skin at the temperature of 45° C., and the amount of pig meat and cacao powder is about 35 wt % and 2.5 wt % of the weight of wet skin. After thoroughly mixing the compound, the compound is degassed in vacuum, shaped in cylindrical shape with model. Then, after placing it for 6 h in order to form a gel, the compound is dryed and dehydrated into stripes.

### EXAMPLE 2

Wet grinde wet pig skins with steel mill after fulling them with water, and maintain a temperature at 70° C. Next, adding pieces of pig meat and cacao powder into the pig skin in the temperature of 55° C., and the amount of pig meat and cacao powder is about 70 wt % and 2.5 wt % of the weight of wet skin. After thoroughly mixing the compound, the compound is degassed in vacuum, shaped in cylindrical shape with model. Then, after placing it for 6 h in order to form a gel, the compound is dryed and dehydrated into 10 mm stripes.

In example 1 and example 2, the wet pig skins can be replaced by wet bison skins; the pig meat can be replaced by fish, birds, vegetables, fruit and/or vegetable juice and fruit juices, and the addition amount could be adjusted according to the content range mentioned ahead; Similarly, wet skins can be obtained from dry skins immersing in water; cacao powder can be replaced by other spices and flavoring, and the addition amount could be adjusted according to the content range mentioned ahead.

### EXAMPLE 3

Wet grinde wet bison skins with steel mill after fulling them with water, and maintain a temperature at 75° C. Next, adding pieces of chicken and cheese powder and TG enzyme into the bison skin in the temperature of 45° C., and the amount of chicken, cheese powder and TG enzyme is about 735 wt %, 1.5 wt % and of 0.5 wt % the weight of wet skin. After thoroughly mixing the compound, the compound is degassed and bubbles are dispelled in vacuum. Then, after shaped in rectangle shape with model and placing for 30 min in order to form a gel, the compound is dryed and dehydrated into 20 mm stripes. The product will be used for granular food packaging.

### EXAMPLE 4

Wet grinde wet bison skins with colloid mill after fulling them with water, and maintain a temperature at 90° C. Next, adding pieces of fish, salt, glucose, pepper, onion powder, milk essence and TG enzyme into the skin in the temperature of 70° C., and the amount of these additions is about 70 wt %, 0.2 wt %, 0.5 wt %, 0.0025 wt %, 0.015 wt %, 0.015 wt %, and 1.0 wt % of the weight of wet skin. After thoroughly mixing the compound, the compound is degassed in vacuum, shaped in rectangle shape with model. Then, after placing it for 5 min in order to form a gel, the compound is dryed and dehydrated into 5 mm stripes.

### EXAMPLE 5

Wet grinde wet bison skins with colloid mill after fulling them with water, and maintain a temperature at 75° C. Next, adding pieces of chicken and TG enzyme into the skin in the temperature of 45° C., and the amount of chicken and TG enzyme is about 40 wt % and 3.5 wt % of the weight of wet skin. After thoroughly mixing the compound, the compound is degassed in vacuum, shaped with model head. Then, after placing it in 300 ppm Ca²⁺ water-bath for 2 min in order to form a gel, the compound is dryed and dehydrated into 1 mm stripes.

### EXAMPLE 6

Wet grinde wet bison skins with steel mill after fulling them with water, and maintain a temperature at 20° C. Next, adding pieces of celery (with its juice) and TG enzyme into the skin, and the amount of celery and TG enzyme is about 20 wt % and 0.8 wt % of the weight of wet skin. After thoroughly mixing the compound, the compound is degassed in vacuum, shaped in rectangle shape with model. Then, after placing it for 3 h in order to form a gel, the compound is dryed and dehydrated into 7 mm stripes.

In example 3-6, the bison skins can be replaced by pig skins, horse skins and/or sheep skins.

### EXAMPLE 7

Wet grinde wet bison skins with colloid mill after fulling them with water, and maintain a temperature at 50° C. Next, adding TG enzyme into the skin in the temperature of 50° C., and the amount of TG enzyme is about 0.1 wt % of the weight of wet skin. After thoroughly mixing the compound, the compound is degassed in vacuum, shaped in rectangle shape with model. Then, after placing it for 70 min in order to form a gel, the compound is dryed and dehydrated into 4 mm reorganized skin. The skin is folded into a spiral shape product.

### EXAMPLE 8

Wet grinde wet bison skins with colloid mill after fulling them with water, and maintain a temperature at 50° C. Next, adding TG enzyme into the skin in the temperature of 50° C., and the amount of TG enzyme is about 3.5 wt % of the weight of wet skin. After thoroughly mixing the compound, the compound is degassed in vacuum, shaped in rectangle shape with model. Then, after placing it for 70 min in order to form a gel, the compound is dryed and dehydrated into 4 mm reorganized skin. The skin is folded into a spiral shape product.

It is noteworthy that the term “aycl/aldehyde-transfer enzyme” in the prospectus refers to an enzyme that catalyses polymerization and crosslinking reaction within a protein molecule, among protein molecules or between the protein molecule and amino acids. TG enzyme is used in detailed examples above; however, having known technologies in this field, technical staff have a clear understanding of that all the aycl/aldehyde-transfer enzyme can achieve this invention. There is no need to enumerate every example of all kinds of aycl/aldehyde-transfer enzymes, because all the aycl/aldehyde-transfer enzymes are of universal application, therefore, the application of aycl/aldehyde-transfer enzymes can be a strong support program.

Detailed explanation is carried out on the invention program in connection with detailed examples. However, the technical staff in this field can easily realize that based on this invention program, there could be various changes and modifications, which are in the scope of the protection of the inventions' right-claiming document.

1. A method of reorganization and molding of animal skins fragmentation includes the following steps:
(1) Wet grinding wet animal skins after fulling them with water;
(2) Adding pieces of animal meat, vegetables, fruit and/or vegetable juice and fruit juices into the comminuted wet shin at the temperature of 20-90° C., and the amount should be less than 70 wt. % of the total weight; and
(3) Directly degassing, shaping, placeing, gelling, and drying the wet skins after mixing them thoroughly, or before the degassing approach, a step to of adding aycl/aldehyde-transfer enzyme which is less than 3.5 wt. % of the i total weight into comminuted wet shin and mixing them thoroughly in temperature of 20-70° C. can also be in the process.

2. The method of claim 1, wherein the addition amount is less than 15 35 wt. % of the total weight which is mentioned in step (2).

3. The method of claim 1, wherein the addition amount of acyl/aldehyde-transfer enzyme is less than 1.0 wt. % of the total weight.

4. The method of claim 3, wherein the addition amount of acyl/aldehyde-transfer enzyme is less than 0.5 wt. % of the total weight.

5. The method of claim 3 wherein the acyl/aldehyde-transfer enzyme is transglutaminase.

6. The method of claim 1, wherein spices and flavoring can be put into the wet skin in step (2), with the addition amount should be less than 2.5 wt. % of the total weight

7. The method of claim 6, wherein the addition amount should be less than 1.5 wt. % of the total weight.

8. The method of claim 6, wherein spices include essence and flavor, and the flavoring includes common salt, white granulated sugar, glucose, cheese powder, cocoa powder, honey, monosodium glutamate, hydrolyzed vegetable protein and yeast extract.

9. The method of claim 1, wherein the wet skins are immersed wet animal skins and the animal skins are dry skins and/or keep-fresh wet skins.

10. The method of claim 1, wherein the animal skins are cowskins and/or pigskins.

11. The method of claim 1, wherein the skins are full skins, first layer skins and/or second layer skins.

12. The method of claim 1, wherein the wet grinding method composing:
Using steel mill or colloid mill or other machine to pulp and redefine the wet skins;
Degassing process can be vacuum degassing; and
Placing process should be standing, and the standing time is 2 min-6 h.

13. Made a reorganized skin according to the method of animal skins fragmentation, reorganization and molding mentioned in claim 1.

14. The method of claim 12, wherein the reorganized skin is 0.2-10 mm thick.

15. The method of claim 12, wherein the reorganized skin is 1-10 mm thick.

16. As is mentioned in claim 13, reorganized skin should be used as feed for pets.

17. The reorganized skin of claim 16, wherein it can be shaped as various io forms of dog chew toys, artificial dog bones or edible pet toys.

18. The reorganized skin of claim 13, it can be directly used for packing.
